(19) United States
(12) Patent Application Publication
(10) Pub. No.: US 2026/0034865 A1
(43) Pub. Date: Feb. 5, 2026

(54) MOTOR VEHICLE OUTER TAILGATE PANEL

(71) Applicant: OPmobility SE, Lyon (FR)

(72) Inventors: Philippe COUDRON, Sainte-Julie (FR); Benoît BRIAND, Sainte-Julie (FR)

(21) Appl. No.: 19/287,971

(22) Filed: Aug. 1, 2025

(30) Foreign Application Priority Data
Aug. 2, 2024 (FR) FR2408573

(51) Int. Cl. B60J 5/10

(52) U.S. Cl. CPC B60J 5/107; B60Y 2410/122; B60Y 2410/125

(57) ABSTRACT

An outer panel of a motor vehicle tailgate intended to be glued to a liner, the outer panel including a main body, a recess forming an optical unit housing and having a lower wall, and a bonding wall extending from the lower wall and including an end portion connected to an upper edge of the outer panel. A first connecting wall extends from the end portion of the bonding wall to an inner face of the main body so as to form a second bonding ramp of the outer panel. An end of the first connecting wall is attached to the inner face of the main body having a thickness less than that of the upper wall of the main body.

### FIELD OF THE INVENTION

The invention relates to plastic motor vehicle tailgates comprising an outer panel and a liner, and more particularly to the outer panels of such tailgates.

### BACKGROUND

FIGS. 1 to 3 show a tailgate 2 according to the prior art. Some body parts, such as the tailgate 2 shown in FIG. 1, usually comprise a liner 4 (or inner panel) forming the structural part of the body part and an outer panel 6 forming a visible skin. The liner 4 and the outer panel 6 are generally bonded together. A glue bead 8 can therefore be applied to the periphery of the inner face of the outer panel to achieve this assembly. For this purpose, it is known, in certain configurations, that the outer panel comprises at least one bonding wall 10 forming a glue-receiving ramp (or bridge) onto which a portion of the glue bead 8 placed on the outer panel is deposited.

Generally speaking, the bonding wall 10 can extend along a side wall 12 of the outer panel, with one of its sides 10′ connected to this side wall 12. A second side 10″ of the bonding wall 10, opposite the side 10′, is not connected to any wall. The bonding wall 10 may, for example, extend from lower walls 14 and 14′ of a recess 16 formed at left 11 and right 11′ ends of the outer panel 6 and forming a housing for an optical unit (these two parts are visible in FIG. 1), to join the upper wall 18 of the outer panel 6, the upper wall being located under the rear window of an assembled tailgate. In other words, a section of the glue bead 8 is applied to the bonding wall section 10 from the upper edge of the inner face 15 of the lower wall 14 (which is part of the inner face 17 of the outer panel 6) to the inner face 17 of the upper wall 18. The bonding wall thus forms a transition slope with as little angular variation as possible between the lower wall 14 of the recess 16 and the upper wall 18. Such a configuration ensures homogeneous bonding by preventing the deposited glue bead 8 from being degraded, or even displaced, from certain zones to be bonded during assembly by bringing the outer panel 6 and the liner 4 into contact under bonding force, due to inadequate angular positioning between the different zones/surfaces involved in bonding. For example, this prevents glue-coated areas/surfaces of the outer panel from extending in a direction substantially parallel to the direction of assembly of the outer panel and the liner. It is advantageous for the angle formed by the bonding wall 10, forming said transition slope, and a bonding direction of the outer panel 6 to the liner 4 to be greater than or equal to 30° in order to achieve the desired effect. This ensures good local bonding between the outer panel and the liner, and homogeneous bonding pressure across the entire glue bead.

In the configuration shown in FIG. 2 and FIG. 3, the bonding wall has an upper end 13 connected to the inner face 17 of the upper wall 18 of the outer panel 6, the glue bead 8 being deposited on the bonding wall 10 and then extending from the latter to said inner face 17, as can be seen in FIGS. 2 and 3. This leads to an aesthetic drawback. Indeed, the connection of the bonding wall 10, by its upper end 13, to the inner face 17 of the outer panel 6 leads to a degradation in appearance due to molding, visible on the outer face 19 of the upper wall 18 of the outer panel opposite the connection zone of the bonding wall 10 connecting to the inner face 17 of the upper wall 18.

To mask this “shrinkage” defect, it is known to create a style line in the area of the outer panel presenting an appearance defect, in line with the end 13, for example by creating a local change in shape of the outer panel, as can be seen in FIG. 3, by creating an angular discontinuity on the outer face 19.

However, some carmakers are unwilling to concede styling adaptations in order to conceal an appearance defect. As a result, it is no longer possible to envisage the bonding wall being connected by an upper end 13 to the middle of the inner face of the outer panel so as to create an appearance defect on the outer face of the outer panel (that is, in an area requiring the use of devices to mask an appearance defect).

In particular, the aim of the invention is to provide an outer panel that can be bonded to a liner without causing any appearance defects of the resulting tailgate and without any stylistic adaptation, while at the same time making it possible to guarantee that an internal volume between the outer panel and the liner is watertight, this watertightness being achieved locally by their assembly using the glue bead at a corner of the outer panel.

### SUMMARY

To this end, the invention relates to an outer panel of a motor vehicle tailgate intended to be bonded to a liner, the outer panel being made of plastic and comprising:
a main body comprising at least one side wall and an upper wall,
a recess forming an optical unit housing and comprising a lower wall,
a bonding wall extending from the lower wall and along the side wall, comprising a first side connected to the side wall, and comprising an end portion connected to an upper edge of the upper wall, the bonding wall forming a first ramp for bonding the outer panel to a liner,
a first connecting wall extending at the end portion of the bonding wall, from a second side of the bonding wall opposite the first side of the bonding wall connected to the side wall, to an inner face of the upper wall of the main body so as to form a second bonding ramp of the outer panel to a liner, an end of the first connecting wall attached to the inner face of the upper wall of the main body having a thickness less than that of the upper wall of the main body.

The structure thus obtained prevents the appearance of visible defects on the outer face of the outer panel and ensures continuity in the deposition of a glue bead. Firstly, the connection of the bonding wall to the upper edge of the outer panel means that the bond is made at the edge of the part rather than on the full skin. This avoids the appearance of shrinkage-type defects, and therefore the need to create a styling line in the area of the outer panel presenting an appearance defect. In addition, the first connecting wall extending from the bonding wall toward the inner face of the outer panel ensures surface continuity of the bonding wall at the end portion and thus continuity of deposition of a glue bead. Finally, the connection of this first bonding wall to the inner face of the outer panel is of lesser thickness, thus avoiding the appearance of a defect and without the risk of breaking this connection, as the bonding pressure is exerted on the bonding wall at its connection to the upper edge of the outer panel.

According to other optional features of the battery system, taken either alone or in combination:
the thickness of the end of the first connecting wall attached to the inner face of the main body is between 10% and 15% of that of the upper wall of the main body,
the angle between the first connecting wall and an outer face of the main body is between 60° and 90°,
the outer panel comprises a second connecting wall connected to the first connecting wall, the bonding wall and the inner face of the main body so as to form a watertight volume delimited by the first connecting wall, the second connecting wall, the bonding wall and the main body, one end of the second connecting wall attached to the inner face of the main body having a thickness less than that of the upper wall of the main body,
the thickness of the end of the second connecting wall attached to the inner face of the main body is between 10% and 15% of that of the upper wall of the main body,
the angle between the second connecting wall and an inner face of the main body is between 60° and 90°, and
the outer panel is made from a material selected from polypropylene, polycarbonate, polyamide, acrylonitrile butadiene styrene or a mixture of polycarbonate and acrylonitrile butadiene styrene.

The invention also relates to a motor vehicle tailgate comprising:
an outer panel according to the invention,
a liner,
a glue bead between the outer panel and the liner to bond the outer panel and liner together and create a watertight internal volume, the glue bead being arranged without discontinuity from the bonding wall to the inner face of the main body by being arranged on the first connecting wall.

Another object of the invention is a method of manufacturing a motor vehicle tailgate outer panel according to the invention using a mold comprising a die, a punch and at least two wedges movable in the same direction and in opposite directions, the method comprising the following steps:
closing the mold,
injecting plastic material forming the outer panel, the first connecting wall being molded between the two movable wedges,
removing the movable wedges by moving them in opposite directions,
opening the mold and removing the outer panel.

### BRIEF DESCRIPTION OF THE FIGURES

The invention will be better understood upon reading the following description, which is provided merely as example and with reference to the appended drawings, wherein:

FIGS. 1 to 3 show a tailgate according to the prior art,

FIG. 4 is a first perspective view of a portion of a tailgate outer panel according to the invention,

FIG. 5 is a perspective view of an angle of a portion of a tailgate outer panel according to the invention,

FIG. 6 is a perspective view of a portion of a tailgate outer panel according to the invention,

FIG. 7 is a first cross sectional view of a portion of an outer tailgate panel according to the invention,

FIG. 8 is a second cross sectional view of a portion of an outer tailgate panel according to the invention, and

FIG. 9 is a local cross sectional view of a mold of a tailgate outer panel according to the invention.

### DETAILED DESCRIPTION

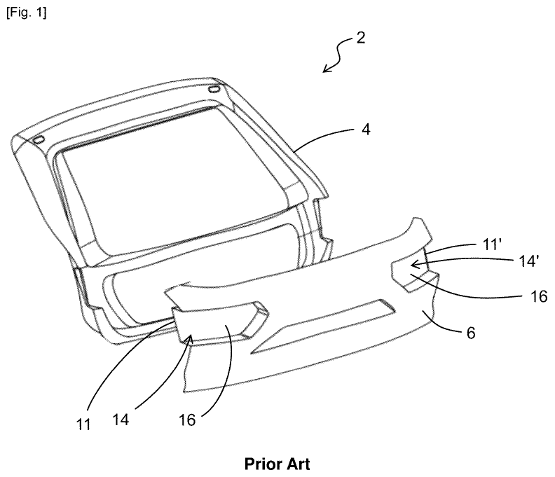

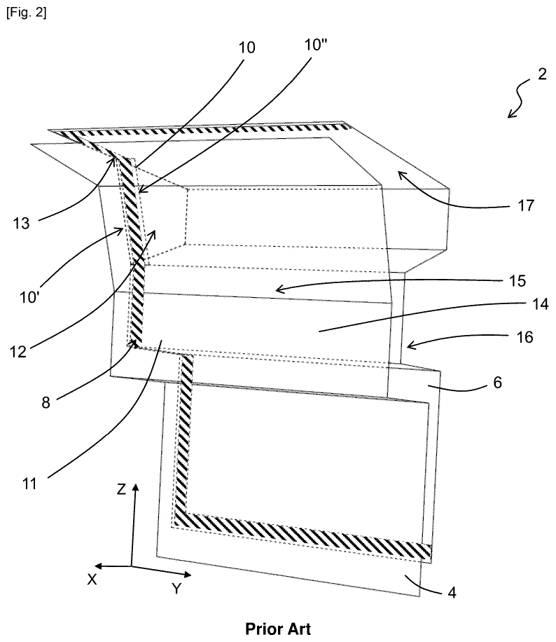

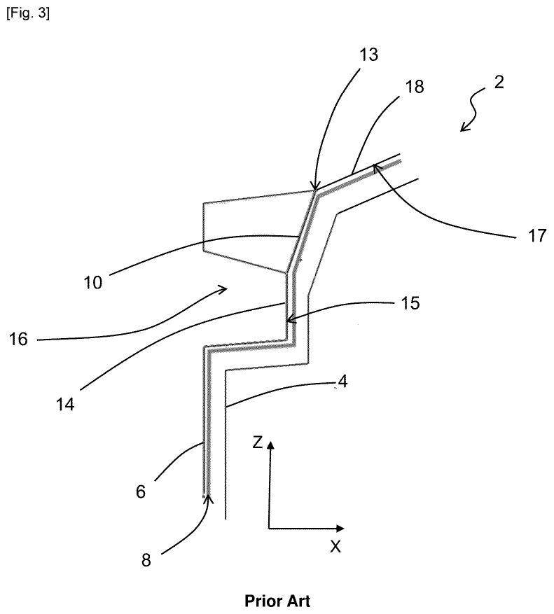

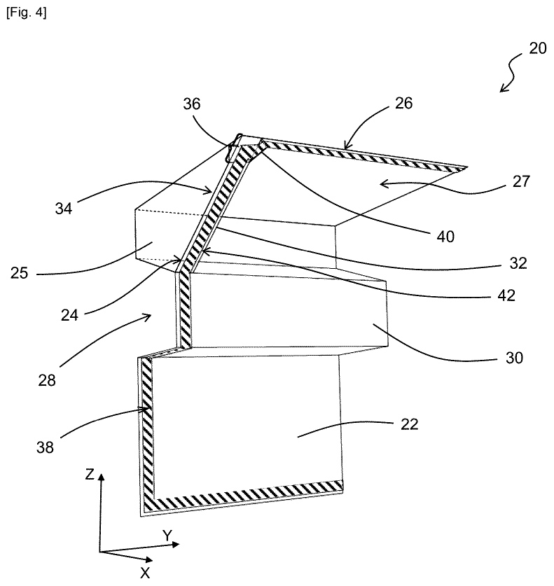

Reference is now made to FIGS. 4 to 6 showing a portion of a motor vehicle tailgate outer panel 20 (which tailgate may be similar to the tailgate 2 of FIG. 1) intended to be bonded to a liner (not shown). FIGS. 4 to 6 show a side of the outer panel 20 comprising an optical unit housing. The same configuration, that is, an outer panel portion comprising a second optical unit housing, is implemented on the other side of the outer panel 20 (not shown in FIGS. 4 to 6, but this configuration is visible in FIG. 1. The outer panel 20 is made of plastic. It can for be made from a material selected from polypropylene, polycarbonate, polyamide, acrylonitrile butadiene styrene or a mixture of polycarbonate and acrylonitrile butadiene styrene.

The outer panel 20 comprises, at the bottom of the tailgate, a main body 22 comprising at least one side edge 24 (locally forming a boundary of a side wall 25) and an upper edge 26 (locally forming a boundary of an upper wall 27).

The outer panel 20 further comprises a recess 28 on its outer face, forming an optical unit housing and comprising a lower wall 30.

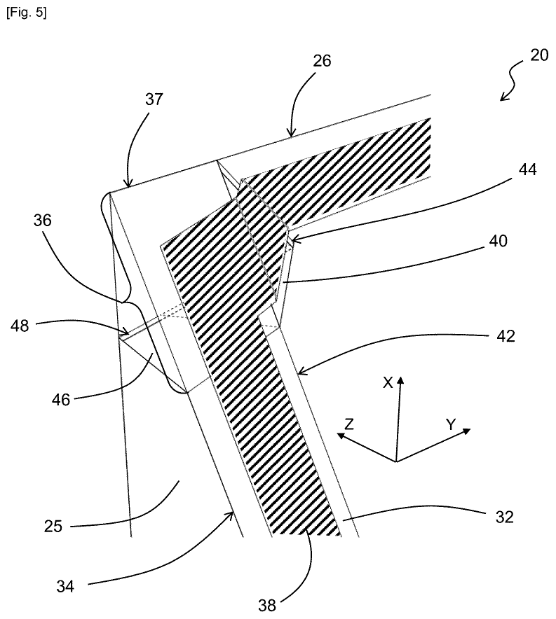

The outer panel 20 further comprises, on its inner face, a bonding wall 32 extending from the lower wall 30 and along the side wall 25, more precisely along the side edge 24. This bonding wall 32 comprises a first side 34 connected to the side edge 24 of the side wall 25, and an end portion 36 connected to the upper edge 26 of the upper wall 27 of the main body 22, the bonding wall 32 forming a first ramp for bonding the outer panel 20 to a liner. Indeed, as shown in FIGS. 4 and 5, a glue bead 38 is deposited on the inner face of the outer panel 20, this glue bead extending peripherally (not shown) along the edge of the outer panel 20 to form a glue track. It is deposited among others on the inner face of the lower wall 30 and on the bonding wall 32, and finally on the upper edge 26. As explained above, the bonding wall 32 on this first ramp forms a transitional slope, as explained for the prior art, between the lower wall 30 of the recess 28 and the upper edge 26 of the upper wall 27 of the outer panel 20 to ensure homogeneous bonding of the outer panel 20 with a liner.

The junction zone 37 between the bonding wall 32 and the upper edge 26 can be between 50% and 75% of the thickness of the rest of the outer panel 20, in particular the thickness of the upper wall 27.

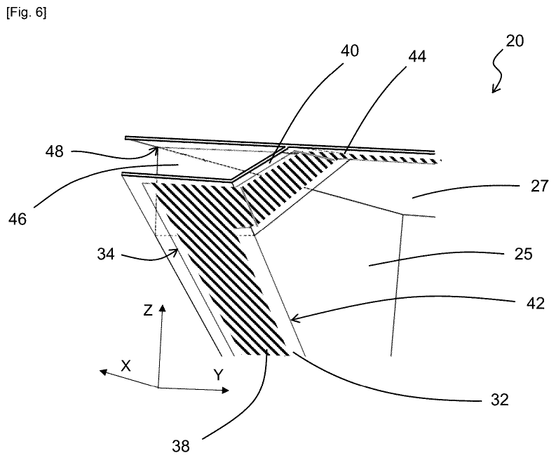

The outer panel 20 further comprises a first connecting wall 40 (particularly visible in FIGS. 5 and 6) extending from the end portion 36 of the bonding wall 32, and from a second side 42 of the bonding wall 32 opposite the first side 34 of the bonding wall 32 connected to the side edge 24, to an inner face of the upper wall 27 of the main body 22 so as to form a second bonding ramp of the outer panel 20 to a liner, one end 44 (visible in FIGS. 5 and 6) of the first bonding wall 40 connected to the inner face of the main body 22 having a thickness less than that of the upper face 27 of the outer panel 20.

The first connecting wall 40 thus provides a junction between the bonding wall 32 and the inner face of the upper wall 27 of the outer panel 20 to ensure surface continuity for depositing the glue bead 38. This surface comprises the bonding wall 32 extending from the lower wall 30 to the upper edge 26 of the upper wall 27, and the first connecting wall 40 for connecting the end portion 36 to the inner face of the upper wall 27 of the outer panel 20. The glue bead 38 is therefore deposited on the perimeter of the inner face of the outer panel 20, and thus on the bonding wall 32 up to the junction at the upper edge 26, and is deposited on the first connecting wall 40 and on the inner face of the outer panel 20 along the upper edge 26. When bonding the outer panel 20 with a liner, the assembly pressure between the outer panel 20 and the liner is locally supported at the junction between the end portion 36 and the upper edge 26.

The first connecting wall 40 allows the glue bead 38 to be deposited continuously, but the connection between the first connecting wall 40 and the inner face of the main body 22 is thinned so as not to generate an appearance defect (molding shrinkage) on the outer face of the upper wall 27 of the main body 22. This thinning is permitted because the bonding forces are taken up and distributed elsewhere. As will be seen later, the connection between the first connecting wall 40 and the inner face of the upper wall of the main body 22 provides a seal in the area where the first connecting wall 40 is provided.

Advantageously, the thickness of the end 44 of the first connecting wall attached to the inner face of the main body 22 is between 10% and 15% of that of the rest of the outer panel. For example, its thickness can be:
between 0.3 and 0.45 millimeters for an outer panel 20 with a thickness substantially equal to 3 millimeters, or
between 0.32 and 0.48 millimeters for an outer panel 20 with a thickness substantially equal to 3.2 millimeters.

The thickness ratio described above avoids both the appearance of defects (as explained above) and very little, if any, risk of breakage of the end 44 of the first connecting wall 40 during bonding (the bonding force being proportional to the surface under pressure, it is taken up, as explained above, by the junction between the end portion 36 of the bonding wall 30 and the upper edge 26).

Advantageously, the angle between the first connecting wall 40 and the outer face of the main body 22 is between 60° and 90°. Such an angle increases the strength of the end 44 of the connecting wall 40, as it favors compressive loading over flexural loading during bonding.

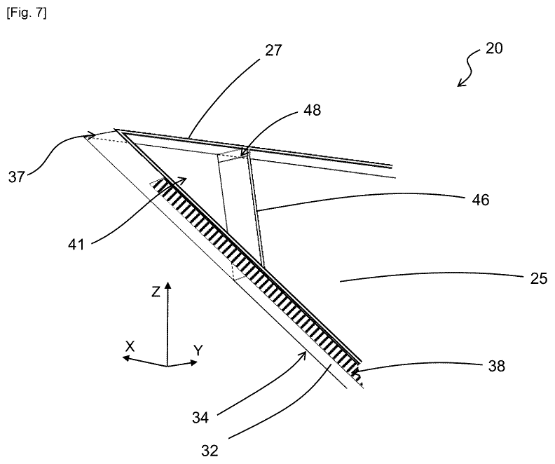

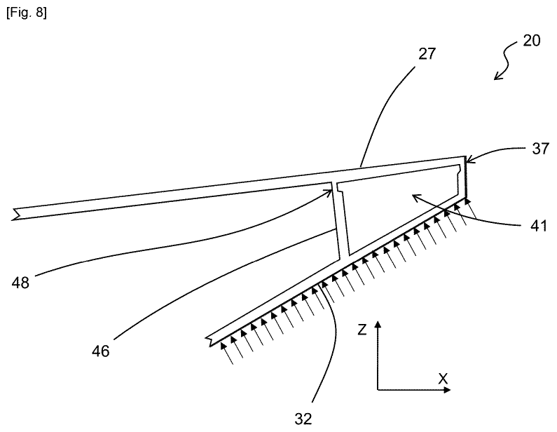

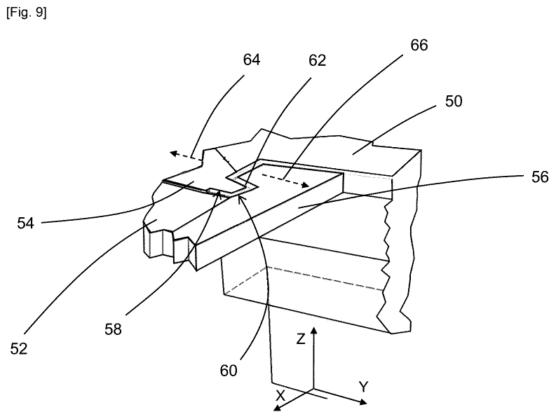

The outer panel 20 may further comprise a second connecting wall 46 (visible in FIGS. 5 to 8) connected to the first connecting wall 40, the bonding wall 32, the side wall 25 and the inner face of the main body 22 so as to form a watertight volume 41 (referenced in FIG. 7) delimited by the first connecting wall 40, the second connecting wall 46, the bonding wall 32 and the main body 22. In fact, as shown in FIG. 9, which shows a mold for the outer panel 20, the first connecting wall 40 is molded by means of movable parts (or movable wedges) of the mold, so as to enable the molded outer panel 20 to be demolded. This leads to the appearance of a discontinuity in the side wall 25 of the outer panel 20 (resulting from the removal of a moving part of the mold). To prevent water from entering the tailgate through this discontinuity, the volume 41 left free by the removal of the movable element is sealed and delimited by the first connecting wall 40, the second connecting wall 46, the bonding wall 30 and the main body 22.

One end 48 of the second connecting wall 46 connected to the inner face of the upper wall 27 of the main body 22 may have a thickness less than that of the upper wall of the main body 22. The thickness ratio can be the same as for the end 44 of the first connecting wall 40 (thickness between 10% and 15% of that of the rest of the upper wall 27). This reduction in thickness achieves the same effects as for the first connecting wall 40 (no appearance defects on the outer face of the main body 22, no risk of this end breaking during bonding).

As with the first connecting wall 40, the angle between the second connecting wall 46 and the outer face of the main body 22 is between 60° and 90°. As with the first connecting wall 40, such an angle increases the strength of the end 48 of the second connecting wall 46, as it favors compressive loading over flexural loading during bonding.

The invention also relates to a motor vehicle tailgate comprising:
the outer panel 20 according to the invention,
a liner,
the glue bead 38 between the outer panel 20 and the liner to bond the outer panel 20 and the liner together and to create a watertight internal volume between the outer panel and the liner,
   the glue bead 38 being arranged without discontinuity from the bonding wall 32 to the inner face of the main body 22 by being arranged on the first connecting wall 40.

Another object of the invention is a method of manufacturing a motor vehicle tailgate outer panel 20 according to the invention using a mold comprising a die 50, a punch 52 and at least two wedges 54 and 56 movable in the same direction and in opposite ways. The method comprises the following steps:
Closing the mold. FIG. 9 shows a “closed mold” position for the movable wedges 54 and 56, die 50 and punch 52. This closed position defines several areas: a first area 58 for molding the bonding wall 32, a second area 60 for molding the first connecting wall 40 and a third area 62 for molding the second connecting wall 46.
Injecting the plastic forming the outer panel 2. The first connecting wall 40 is molded between the two movable wedges 54 and 56, as is the second connecting wall 46.
Removing the movable wedges 54 and 56 by moving in opposite ways 64 and 66. This removal in two opposite ways frees the molded outer panel 20 for removal from the mold. Removal of the movable wedge 54 leads to the discontinuity in the side wall of the outer panel 20 described above, requiring the creation of a watertight volume 41 to prevent water from entering the tailgate.
Opening the mold and removing the outer panel 20.

The invention is not limited to the embodiments presented, and other embodiments will become clearly apparent to a person skilled in the art.

### LIST OF REFERENCES

2: tailgate
4: liner
6, 20: outer panel
8, 38: glue bead
10, 32: bonding wall
11, 11′: ends of the outer panel
12, 25: side wall
13: upper end of bonding wall
14, 14′, 30: lower wall
15: inner face of the lower wall
16, 28: recess
17: inner face of the upper wall
18, 27: upper wall
19: outer face of the upper wall 18
22: main body
24: side edge
26: upper edge
10′, 34: first side of the bonding wall
36: end portion of the bonding wall
37: junction area
40: first connecting wall
41: volume
10″, 42: second side of the bonding wall
44: end of the first connecting wall
46: second connecting wall
48: end of the second connecting wall
50: die
52: punch
54, 56: movable wedges
58: first area
60: second area
62: third area
64, 66: removal directions of the mobile wedges

1. An outer panel of a motor vehicle tailgate intended to be glued to a liner, the outer panel being made of plastic and comprising:
a main body comprising at least one side wall and an upper wall,
a recess forming an optical unit housing and comprising a lower wall, and
a bonding wall extending from the lower wall and along the side wall, comprising a first side connected to the side wall, and comprising an end portion connected to an upper edge of the upper wall, the bonding wall forming a first ramp for bonding the outer panel to a liner,
a first connecting wall extending at the end portion of the bonding wall, from a second side of the bonding wall opposite the first side of the bonding wall connected to the side wall, to an inner face of the main body so as to form a second bonding ramp of the outer panel to a liner, an end of the first connecting wall attached to the inner face of the main body having a thickness less than that of the upper wall of the main body.

2. The outer panel according to claim 1, wherein the thickness of the end of the first connecting wall attached to the inner face of the main body is between 10% and 15% of that of the upper wall of the main body.

3. The outer panel according to claim 2, wherein an angle between the first connecting wall and the outer face of the main body is between 60° and 90°.

4. The outer panel according to claim 3, comprising a second connecting wall connected to the first connecting wall, the bonding wall and the inner face of the main body so as to form a watertight volume delimited by the first connecting wall, the second connecting wall, the bonding wall and the main body, one end of the second connecting wall attached to the inner face of the main body having a thickness less than that of the upper wall of the main body.

5. The outer panel according to claim 4, wherein the thickness of the end of the second connecting wall attached to the inner face of the main body is between 10% and 15% of that of the upper wall of the main body.

6. The outer panel according to claim 5, wherein the angle between the second connecting wall and the inner face of the main body is between 60° and 90°.

7. The outer panel according to claim 6, the outer panel being made from a material selected from polypropylene, polycarbonate, polyamide, acrylonitrile butadiene styrene or a mixture of polycarbonate and acrylonitrile butadiene styrene.

8. The outer panel according to claim 1, wherein an angle between the first connecting wall and the outer face of the main body is between 60° and 90°.

9. The outer panel according to claim 1, comprising a second connecting wall connected to the first connecting wall, the bonding wall and the inner face of the main body so as to form a watertight volume delimited by the first connecting wall, the second connecting wall, the bonding wall and the main body, one end of the second connecting wall attached to the inner face of the main body having a thickness less than that of the upper wall of the main body.

10. The outer panel according to claim 1, wherein the thickness of the end of the second connecting wall attached to the inner face of the main body is between 10% and 15% of that of the upper wall of the main body.

11. The outer panel according to claim 1, wherein an angle between the second connecting wall and the inner face of the main body is between 60° and 90°.

12. The outer panel according to claim 1, the outer panel being made from a material selected from polypropylene, polycarbonate, polyamide, acrylonitrile butadiene styrene or a mixture of polycarbonate and acrylonitrile butadiene styrene.

13. A motor vehicle tailgate comprising:
the outer panel according to claim 1,
a liner,
a glue bead between the outer panel and the liner to bond the outer panel to the liner and create a watertight interior between them,
the glue bead being arranged without discontinuity from the bonding wall to the inner face of the main body by being arranged on the first connecting wall.

14. A method of manufacturing the outer panel of the motor vehicle tailgate according to claim 1 using a mold comprising a die, a punch and at least two wedges movable in a same direction and in opposite ways, the method comprising steps of:
closing the mold,
injecting plastic material forming the outer panel, the first connecting wall being molded between the two movable wedges,
removing the movable wedges by moving them in opposite directions,
opening the mold and removing the outer panel.
